(19) United States
(12) Patent Application Publication
(10) Pub. No.: US 2024/0273352 A1
(43) Pub. Date: Aug. 15, 2024

(54) SYSTEMS AND METHODS FOR CUSTOMIZED MACHINE-LEARNING-BASED MODEL SIMPLIFICATION FOR CONNECTED VEHICLES

(71) Applicant: Toyota Motor Engineering & Manufacturing North America, Inc., Plano, TX (US)

(72) Inventors: Yongkang Liu, Mountain View, CA (US); Emrah A. Sisbot, Menlo Park, CA (US); Yashar Zeiynali Farid, Berkeley, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/107,757

(22) Filed: Feb. 9, 2023

(51) Int. Cl. G06N 3/08; B60W 60/00; G05D 1/00

(52) U.S. Cl. CPC G06N 3/08; B60W 60/00; B60W 2556/45

(57) ABSTRACT

Systems and methods described herein relate to customized machine-learning-based model simplification for connected vehicles. One embodiment executes a first training procedure for a machine-learning-based teacher model and performs the following repeatedly until convergence occurs: (1) distributing, to connected vehicles, a set of teacher-model parameters from the teacher model; (2) receiving, from each connected vehicle, a set of student-model parameters for a student model trained through a second training procedure employing first knowledge distillation to mimic the teacher model, wherein the student model is less complex than the teacher model; and (3) executing a third training procedure including second knowledge distillation in which a combined model from the sets of student-model parameters acts as a quasi-teacher model to update the teacher model. After convergence, a vehicular application, instantiated in a connected vehicle, controls operation of the connected vehicle based, at least in part, on the student model in the connected vehicle.

### TECHNICAL FIELD

The subject matter described herein relates in general to vehicles and, more specifically, to systems and methods for customized machine-learning-based model simplification for connected vehicles.

### BACKGROUND

Modern machine-learning-based models (e.g., models employing neural networks) can yield impressive performance but often have complex architectures, involve a very large number of parameters, and require significant computing resources. These characteristics make such models less feasible for real-time applications deployed in connected vehicles.

### SUMMARY

Embodiments of a system for customized machine-learning-based model simplification for connected vehicles are presented herein. In one embodiment, the system comprises a processor and a memory storing machine-readable instructions that, when executed by the processor, cause the processor to execute a first training procedure to train a teacher model. The teacher model is a machine-learning-based model pertaining to a vehicular application. The memory also stores machine-readable instructions that, when executed by the processor, cause the prosses to perform the actions that follow repeatedly until one or more predetermined convergence criteria have been satisfied. First, the memory stores machine-readable instructions that, when executed by the processor, cause the processor to distribute, via a network to a plurality of connected vehicles, a set of teacher-model parameters associated with the teacher model. Second, the memory stores machine-readable instructions that, when executed by the processor, cause the processor to receive, via the network from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters. The student model in each connected vehicle in the plurality of connected vehicles is less complex than the teacher model and is customized, via the second training procedure, for that connected vehicle. Third, the memory stores machine-readable instructions that, when executed by the processor, cause the processor to execute a third training procedure including second knowledge distillation in which a combined machine-learning-based model based on the sets of student-model parameters is used as a quasi-teacher model to update the teacher model, the teacher model being treated, during the third training procedure, as a quasi-student model. After the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

Another embodiment is a non-transitory computer-readable medium for configuring a hierarchical traffic management system and storing instructions that, when executed by a processor, cause the processor to execute a first training procedure to train a teacher model. The teacher model is a machine-learning-based model pertaining to a vehicular application. The instructions also cause the processor to perform the actions that follow repeatedly until one or more predetermined convergence criteria have been satisfied. First, the instructions cause the processor to distribute, via a network to a plurality of connected vehicles, a set of teacher-model parameters associated with the teacher model. Second, the instructions also cause the processor to receive, via the network from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters. The student model in each connected vehicle in the plurality of connected vehicles is less complex than the teacher model and is customized, via the second training procedure, for that connected vehicle. Third, the instructions also cause the processor to execute a third training procedure including second knowledge distillation in which a combined machine-learning-based model based on the sets of student-model parameters is used as a quasi-teacher model to update the teacher model, the teacher model being treated, during the third training procedure, as a quasi-student model. After the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

Another embodiment is a method of customized machine-learning-based model simplification for connected vehicles, the method comprising executing a first training procedure for a teacher model hosted by a server. The teacher model is a machine-learning-based model pertaining to a vehicular application. The method also includes performing the following actions repeatedly until one or more predetermined convergence criteria have been satisfied. First, the method also includes distributing, via a network from the server to a plurality of connected vehicles, a set of teacher-model parameters associated with the teacher model. Second, the method also includes receiving, via the network at the server from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters. The student model in each connected vehicle in the plurality of connected vehicles is less complex than the teacher model and is customized, via the second training procedure, for that connected vehicle. Third, the method also includes executing, at the server, a third training procedure including second knowledge distillation in which a combined machine-learning-based model based on the sets of student-model parameters is used as a quasi-teacher model to update the teacher model, the teacher model being treated, during the third training procedure, as a quasi-student model. After the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is an overview of customized machine-learning-based model simplification, in accordance with various illustrative embodiments of the invention.

FIG. 2 illustrates student models in connected vehicles being customized by driver and geographic region, in accordance with an illustrative embodiment of the invention.

FIG. 3 is a block diagram of a server that hosts a system for customized machine-learning-based model simplification for connected vehicles, in accordance with an illustrative embodiment of the invention.

FIG. 4 is a flowchart of a method of customized machine-learning-based model simplification for connected vehicles, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for customized machine-learning-based model simplification for connected vehicles described herein employ distributed bi-directional knowledge distillation to train, onboard a connected vehicle, a simpler, less computationally intensive version of a complex machine-learning-based model hosted on a remote server (e.g., a cloud server). The simplified model that these various embodiments produce can maintain a level of performance comparable to the complex server-based model and can be customized based on a particular driver's driving style/behavior, the geographic region in which the connected vehicle is driven, or other factors. Such a customized simplified model can perform better than a general model. Herein, a “connected vehicle” is a vehicle that is capable of communicating with other network nodes (e.g., servers, the Internet, other connected vehicles) over a network. For example, a connected vehicle can communicate with other network nodes via a technology such as cellular data (LTE, 5G, 6G, etc.).

An important aspect of these various embodiments is a technique known in the art as knowledge distillation. The embodiments described herein apply knowledge distillation in a novel bi-directional manner in which the training of student models in the connected vehicles and the updating of the teacher model on the server can be performed simultaneously. This is explained in greater detail below. In preparation for that fuller explanation, a brief introduction to the topic of knowledge distillation will first be provided.

Knowledge distillation involves training a “student model” (e.g., a machine-learning-based model with relatively few parameters and/or a simple architecture) to mimic a “teacher model” (e.g., a powerful machine-learning-based model that has many parameters and/or a complex architecture). One knowledge-distillation approach is to compare the output probabilities of the teacher model with those of the student model via a divergence measure such as Kullback-Leibler (KL) Divergence. The divergence measure is then summed with a distillation loss function, and that loss is minimized during the training process to improve the student model's performance (i.e., to minimize the divergence between the estimates/predictions output by the student model and those output by the teacher model).

The resulting trained student model in a connected vehicle can support any of a variety of vehicular applications, including, without limitation, computer vision, a range-estimation service, a distracted-driver-detection application, an impaired-driver-detection application, and an application that automatically customizes vehicle settings for a particular driver based on the driver's learned behavior, habits, and/or preferences. A vehicular application, instantiated in a connected vehicle, can control operation of the connected vehicle based, at least in part, on the trained student model. Such control can include manipulation of a variety of vehicle settings and functions, including, without limitation, acceleration, braking, and steering.

One important advantage of the various embodiments described herein is that the student model and the teacher model do not necessarily have to have the same underlying architecture. In some embodiments, they do have the same architecture, but in other embodiments, they do not. Another advantage is that the teacher model and the student model do not have to be trained using the same data set. Each connected vehicle can train its onboard student model using its own local data, and the teacher model can be trained using separate data (e.g., data available to a server that hosts the teacher model). This is particularly advantageous where data privacy is a concern, since the local data used to train a particular connected vehicle's student model never has to leave that connected vehicle (e.g., does not need to be uploaded to a central server that hosts the teacher model). This also reduces the amount of data that needs to be transmitted from the connected vehicles to the server, conserving network bandwidth.

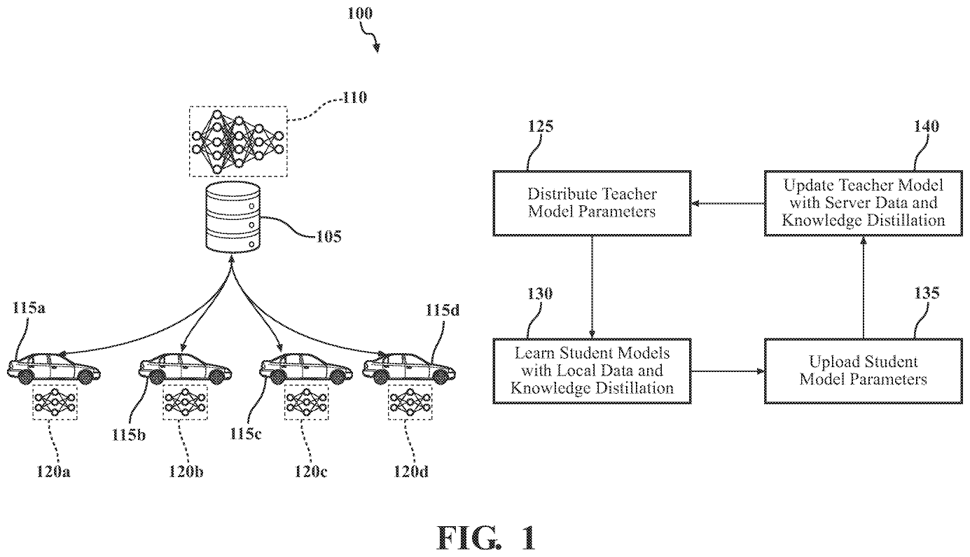

FIG. 1 is an overview 100 of customized machine-learning-based model simplification, in accordance with various illustrative embodiments of the invention. The left side of FIG. 1 illustrates an architecture of a system for customized machine-learning-based model simplification, and the right side of FIG. 1 illustrates a high-level overview of the process flow of such a system.

Referring to the left side of FIG. 1, a server 105 hosts a teacher model 110. In some embodiments, the server 105 is a cloud server. Depending on the embodiment, the server 105 may be a central server that serves a large geographic region (e.g., a country/nation), or it may be a server assigned to a smaller geographic region (e.g., a city or portion of a city) in a hierarchy of servers that cover a nation/country. The server 105 can communicate bidirectionally with one or more connected vehicles 115 over a network. For example, in some embodiments, the server 105 and the connected vehicles 115 communicate wirelessly via a technology such as cellular data (LTE, 5G, 6G, etc.). In some embodiments, other communication technologies such as Dedicated Short-Range Communications (DSRC) and Bluetooth® Low Energy (LE), etc., can also be employed for short-range communication. As shown in FIG. 1, the connected vehicles 115a-d are equipped with onboard student models 120a-d, respectively. That is, each connected vehicle 115 has onboard computing capabilities (processor(s), memory, etc.) to store, train, and execute a student model 120 for that connected vehicle. The connected vehicles 115 can be manually driven, semi-autonomous, or fully autonomous, depending on the embodiment.

Referring to the right side of FIG. 1, a preliminary aspect of the process flow is executing a training procedure at the server 105 to at least partially train the teacher model 110 using input (training) data that is available to the server 105. In some embodiments, the input data comes from publicly available sources, including publicly available research training datasets that are well known in the art. In some embodiments, due to data privacy concerns and restrictions, the amount of training data available to the server may be somewhat limited compared to the amount of local training data that is available to the connected vehicles 115 by virtue of their onboard sensor systems.

Once the teacher model 110 has been at least partially trained, an iterative (repeated) processing loop including blocks 125, 130, 135, and 140 in FIG. 1 commences and continues until one or more predetermined convergence criteria have been satisfied. Convergence is discussed in greater detail below. At block 125, the server 105 distributes, to the connected vehicles 115 via the network, a set of teacher-model parameters associated with the teacher model 110. The set of teacher-model parameters specifies or defines the teacher model 110. In some embodiments, the set of teacher-model parameters includes neural-network weights of the at least partially trained teacher model 110. The set of teacher-model parameters is sufficient to enable a connected vehicle 115 to simulate what the output of the teacher model 110 would be, given the local input training data. This makes it possible for the onboard computing system of a connected vehicle 115 to perform knowledge distillation on its locally hosted student model 120, as discussed further below.

Once a given connected vehicle 115 has received the set of teacher-model parameters, that connected vehicle 115 trains its own student model 120 using local data and knowledge distillation (block 130). This local data can encompass a wide variety of different kinds of local user data, including, without limitation, environment-sensor data (images, Light Detection and Ranging (LIDAR), radar, sonar, etc.), driver-monitoring data (images of the driver captured inside the passenger compartment, biometric data, audio, etc.), Controller-Area-Network (CAN) bus data, Inertial-Measurement-Unit (IMU) data, dead-reckoning data, and Global-Positioning-System (GPS) data. In general, the local data can include data from any exterior or interior sensor of the vehicle and any other data pertaining to the operation and status of the vehicle.

Since the teacher model 110 is expected, at least initially, to have better performance than the student model 120 because of its more complex model architecture, knowledge distillation is used whether the teacher model 110 is a well-trained model or only a partially-trained model. In some embodiments, if, in the early stages of the iterative process shown in FIG. 1, the partially-trained teacher model 110 has worse performance than the student models 120 in the connected vehicles 115, the student models 120 can be updated using a traditional training approach without knowledge distillation until the teacher model 110 achieves a higher level of performance in later iterations. Otherwise, during this second phase of the process flow, both the teacher model 110 and the student model 120, at the connected vehicle 115, are applied to the connected vehicle's own local dataset. This knowledge distillation is possible because the connected vehicle 115 has received the set of teacher-model parameters from the server 105, as discussed above. In some embodiments, the knowledge-distillation loss function is designed in accordance with the KL Divergence mentioned above.

In some embodiments, the server 105 distributes to the connected vehicles 115, in the set of teacher-model parameters, a complete set of weights defining the teacher model 110. In other embodiments, the set of teacher-model parameters includes a subset of the complete set of parameters defining the teacher model 110. In those embodiments, a tool such as the Fisher Information Matrix can be used to identify the important weights of the teacher model 110 (the weights that have the greatest impact on the model's performance), and a student model 120 having the same architecture can be trained with a penalty on altering the important weights of the teacher model 110 (e.g., Elastic Weight Consolidation).

Once the student-model parameters of the respective student models 120 in the connected vehicles 115 have been updated through the training and knowledge-distillation process described above, each connected vehicle 115 uploads its set of student-model parameters to the server 105 (block 135). Since only the set of student-model parameters needs to be uploaded, the user's (e.g., driver's, vehicle owner's) personal data does not leave the connected vehicle 115, protecting the user's privacy. As with the set of teacher-model parameters discussed above, the sets of student-model parameters from the connected vehicles 115 include neural-network weights that define or specify the associated student model 120.

In the next phase of the process flow (block 140), since each student model 120 has processed additional unique local data and has updated its model parameters, it is presumed that the student models 120 possess more knowledge than the teacher model 110 on the server 105. Consequently, the teacher model 110 is updated. This is accomplished through knowledge distillation in a manner analogous to that described above in connection with the training of the student models 120. In the process flow illustrated in FIG. 1, knowledge distillation is thus bi-directional. That is, knowledge distillation is used to train/update both the student models 120 and the teacher model 110. There is, however, an important difference between knowledge distillation, as applied to the student models 120 and knowledge distillation, as applied to the teacher model 110. At block 140, the teacher model 110 on the server 105 is treated, during the training/updating process, as a “quasi-student model,” and the combined sets of student-model parameters the server 105 has received from the connected vehicles 115 are treated as a “quasi-teacher model.” That is, the combined sets of student-model parameters are used as if they were a “teacher model” to update the teacher model 110, which is treated as if it were a “student model.”

How the sets of student-model parameters from a plurality of connected vehicles 115 are combined differs, depending on the embodiment. In some embodiments, the parameters (e.g., neural-network weights) of the student models 120 are averaged or combined via a weighted average. Alternatively, the knowledge distillation process can be performed N separate times, once for each student model 120 (i.e., once for each uploaded set of student-model parameters), and then mathematical techniques can be used to combine the results/outputs from the N separate, different knowledge distillations. One advantage of knowledge distillation is that it produces an “intermediate result” that can be used as additional information to update the teacher model 110 on the server 105, and that does not require that the underlying architectures of the student models 120 and teacher model 110 be the same, as discussed above.

During updating of the teacher model 110 at block 140, the data used to train the teacher model 110 (the quasi-student model) can differ, depending on the embodiment. In some embodiments, the server 105 obtains new user data (e.g., data from the connected vehicles 115) for that purpose, where privacy is not an issue. Due to privacy issues, however, in other embodiments the server 105 might not be able to acquire new user data. In those embodiments, the server 105 can rely on training data available from public sources, as discussed above.

The actions discussed above in connection with blocks 125, 130, 135, and 140 are repeated (performed iteratively) until one or more predetermined convergence criteria have been satisfied. Such convergence criteria can be based on factors such as performance or the passage of time (e.g., number of iterations completed or elapsed time), depending on the embodiment. In some embodiments, once the teacher model 110 and student models 120 have reached a level of satisfactory performance, in accordance with one or more predetermined convergence criteria, the weights of the neural networks in the teacher model 110 and student models 120 are “frozen” (no longer updated). In other embodiments, the teacher model 110 and student models 120 continue to be updated from time to time through additional rounds of the process flow illustrated in FIG. 1 (blocks 125, 130, 135, and 140). One advantage of permitting the model weights to “evolve” over time is that a student model 120 can be updated to reflect that the driver/owner of the associated connected vehicle 115 has changed, that the geographical location at which the connected vehicle 115 is driven has changed, or that other relevant factors have changed that impact the customization/personalization of the student model 120.

The student models 120 that result from the process flow discussed above in connection with FIG. 1 can achieve performance similar to the teacher model 110 but with the advantage of user/driver customization (based on driving style, location, etc.) and the consumption of fewer computational resources than the teacher model 110.

Once the one or more predetermined convergence criteria have been satisfied, a vehicular application, instantiated in at least one connected vehicle 115 among a plurality of connected vehicles 115, can control the operation of the at least one connected vehicle 115 based, at least in part, on the trained student model 120 in the at least one connected vehicle 115. As discussed above, such control can include manipulation of a variety of vehicle settings and functions, including, without limitation, acceleration, braking, and steering.

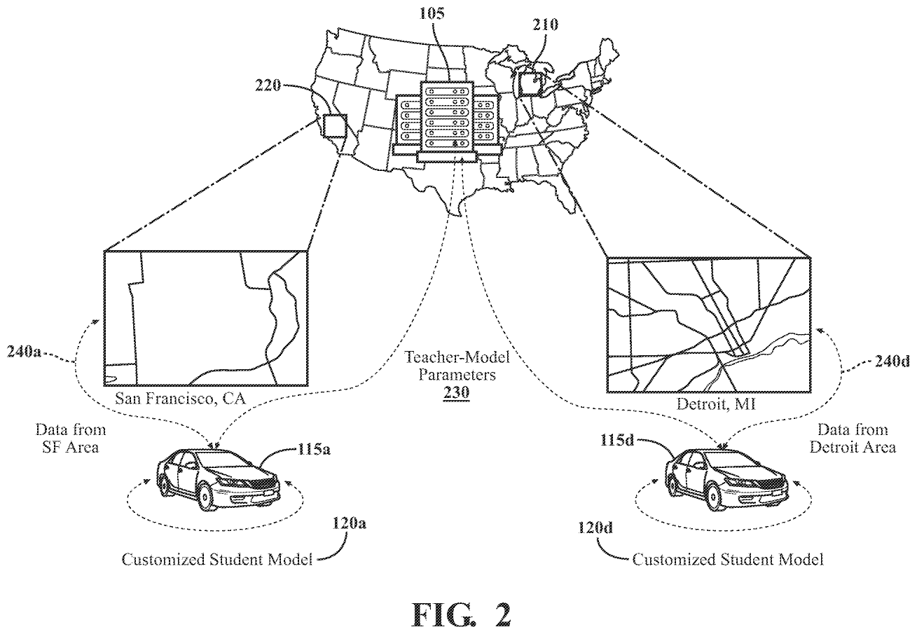

FIG. 2 illustrates student models 120 in connected vehicles 115 being customized by driver and geographic region, in accordance with an illustrative embodiment of the invention. In the embodiment of FIG. 2, a central server 105 serves the continental United States in connection with a range-estimation service. Server 105 communicates over a network with a connected vehicle 115a in the San Francisco, CA area (geographic region 220 in FIG. 2) and a connected vehicle 115d in the Detroit, MI area (geographic region 210 in FIG. 2). Because of the differences between the San Francisco area and the Detroit area, including terrain, ambient temperature, and driving style, a unified general model is unable to provide the best range estimates.

During the training and knowledge-distillation process described above in connection with FIG. 1, server 105 distributes teacher-model parameters 230 to connected vehicle 115a and connected vehicle 115d. Connected vehicles 115a and 115d, in turn, upload their respective sets of student-model parameters, as explained above, to support updating the teacher model 110 on the server 105 via knowledge distillation. The associated student models 120a and 120d, respectively, benefit from data 240a (data from and regarding the San Francisco, CA area) and data 240d (data from and regarding the Detroit, MI area). The result is that the student models 120a and 120d are customized for their respective users/drivers based on the geographical region in which the respective connected vehicles are located, the users'/drivers' respective driving styles, etc. Consequently, the student models 120a and 120d produce better results than a general model.

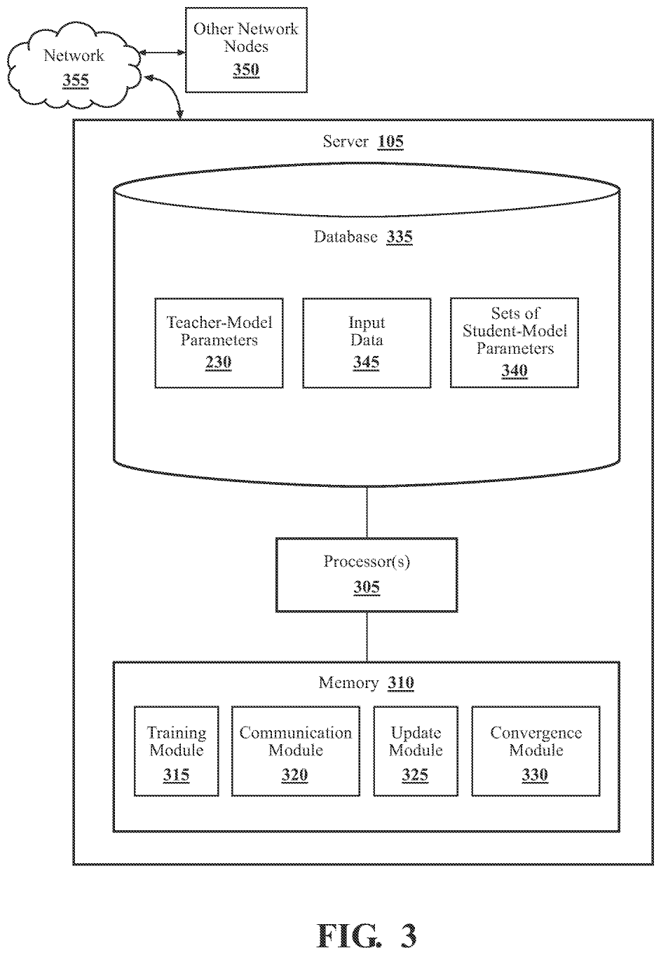

FIG. 3 is a block diagram of a server 105 that hosts a system for customized machine-learning-based model simplification for connected vehicles, in accordance with an illustrative embodiment of the invention. In FIG. 3, server 105 includes one or more processors 305 to which a memory 310 is communicably coupled. Memory 310 stores a training module 315, a communication module 320, an update module 325, and a convergence module 330. The memory 310 is a random-access memory (RAM), read-only memory (ROM), a hard-disk drive, a flash memory, or other suitable non-transitory memory for storing the modules 315, 320, 325, and 330. The modules 315, 320, 325, and 330 are, for example, machine-readable instructions that, when executed by the one or more processors 305, cause the one or more processors 305 to perform the various functions disclosed herein.

As shown in FIG. 3, server 105 can store various kinds of data in a database 335. For example, server 105 can store teacher-model parameters 230, sets of student-model parameters 340 received from connected vehicles 115, and input data 345 (input data available to the server 105). As also shown in FIG. 3, server 105 can communicate with other network nodes 350 (connected vehicles 115, other servers, infrastructure devices, etc.) via a network 355. In some embodiments, network 355 includes the Internet. In communicating with other network nodes 350, server 105 uses communication technologies such as high-speed Ethernet, fiber-optic connections, cellular data (LTE, 5G, 6G, etc.), DSRC, Bluetooth® LE, etc.

Training module 315 generally includes machine-readable instructions that, when executed by the one or more processors 305, cause the one or more processors 305 to execute a first training procedure for a teacher model 110 in preparation for an iterative process in which the student models 120 and teacher model 110 are trained using knowledge distillation (see FIG. 1, blocks 125, 130, 135, and 140). As explained above, the teacher model 110 is a machine-learning-based model pertaining to a vehicular application such as, without limitation, computer vision, a range-estimation service, a distracted-driver-detection application, an impaired-driver-detection application, or an application that automatically customizes vehicle settings for a particular driver. As discussed above, the first training procedure may only partially train the teacher model 110. A portion of the iterative loop (see FIG. 1, block 140) includes the updating of the teacher model 110 through knowledge distillation.

Communication module 320 generally includes machine-readable instructions that, when executed by the one or more processors 305, cause the one or more processors 305 to distribute, via a network 355 to a plurality of connected vehicles 115, a set of teacher-model parameters 230 associated with the teacher model 110. As discussed above, the set of teacher-model parameters 230 specifies or defines the teacher model 110. In some embodiments, the set of teacher-model parameters includes neural-network weights of the at least partially trained teacher model 110.

Communication module 320 also includes machine-readable instructions that, when executed by the one or more processors 305, cause the one or more processors 305 to receive, via the network from each connected vehicle 115 in the plurality of connected vehicles 115, a set of student-model parameters 340 associated with a student model 120 trained at that connected vehicle 115 through execution of a second training procedure that employs local vehicle input data and knowledge distillation to teach the student model 120 to mimic the teacher model 110 based on the set of teacher-model parameters 230. As explained above, the student model 120 in each connected vehicle 115 in the plurality of connected vehicles 115 is less complex than the teacher model 110 and is customized, via the second training procedure, for that connected vehicle 115. The training of the student models 120 in the respective connected vehicles 115 and the uploading, to the server 105, of the sets of student-model parameters 340 are discussed in greater detail above in connection with FIG. 1, blocks 130 and 135.

Update module 325 generally includes machine-readable instructions that, when executed by the one or more processors 305, cause the one or more processors 305 to execute a third training procedure that also includes a knowledge-distillation procedure in which a combined machine-learning-based model based on the sets of student-model parameters 340 is used as a quasi-teacher model to update the teacher model 110, the teacher model 110 being treated, during the third training procedure, as a quasi-student model, as discussed above in connection with FIG. 1, block 140. As discussed above, how the sets of student-model parameters 340 from a plurality of connected vehicles 115 are combined differs, depending on the embodiment. In some embodiments, the parameters 340 of the student models 120 are averaged or combined via a weighted average. Alternatively, the knowledge distillation process can be performed N separate times, once for each student model 120 (i.e., once for each uploaded set of student-model parameters 340), and then mathematical techniques can be used to combine the results/outputs from the N separate, different knowledge distillations.

Convergence module 330 generally includes machine-readable instructions that, when executed by the one or more processors 305, cause the one or more processors 305 to determine whether the repeated actions described above in connection with communication module 320 and update module 325 (blocks 125, 130, 135, and 140 in FIG. 1) have satisfied one or more predetermined convergence criteria. As discussed above, the predetermined convergence criteria can be based on factors such as the performance of the machine-learning-based models being trained or the passage of time (e.g., the number of iterations completed or the elapsed time), depending on the embodiment. As also discussed above, in some embodiments, once the teacher model 110 and student models 120 have reached a level of satisfactory performance, in accordance with the one or more predetermined convergence criteria, the weights of the neural networks in the teacher model 110 and student models 120 are “frozen” (no longer updated). In other embodiments, the teacher model 110 and student models 120 continue to be updated from time to time through additional rounds of the process flow illustrated in FIG. 1 (blocks 125, 130, 135, and 140).

Once the one or more predetermined convergence criteria have been satisfied, a vehicular application, instantiated in at least one connected vehicle 115 among a plurality of connected vehicles 115, can control the operation of the at least one connected vehicle 115 based, at least in part, on the trained student model 120 in the at least one connected vehicle 115. As discussed above, such control can include manipulation of a variety of vehicle settings and functions, including, without limitation, acceleration, braking, and steering.

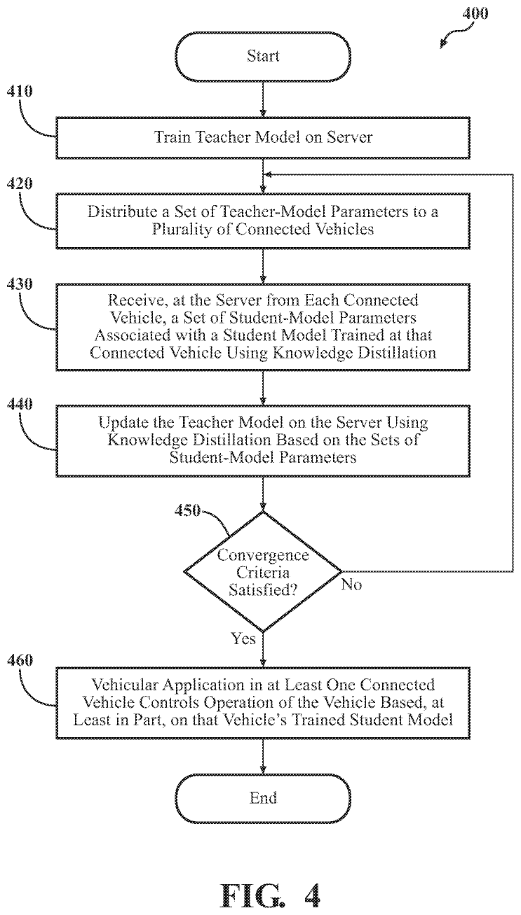

FIG. 4 is a flowchart of a method 400 of customized machine-learning-based model simplification for connected vehicles 115, in accordance with an illustrative embodiment of the invention. Method 400 will be discussed from the perspective of the server 105 in FIG. 3 with reference to FIG. 1. While method 400 is discussed in combination with server 105, it should be appreciated that method 400 is not limited to being implemented within server 105, but server 105 is instead one example of a platform hosting a system for customized machine-learning-based model simplification for connected vehicles that can implement method 400.

At block 410, training module 315 executes a first training procedure for a teacher model 110 hosted by a server 105 in preparation for an iterative process in which the student models 120 and teacher model 110 are trained using knowledge distillation (see FIG. 1, blocks 125, 130, 135, and 140). As discussed above, the teacher model 110 is a machine-learning-based model pertaining to a vehicular application. As also discussed above, the vehicular application can be, without limitation, computer vision, a range-estimation service, a distracted-driver-detection application, an impaired-driver-detection application, or an application that automatically customizes vehicle settings for a particular driver. As explained above, the first training procedure may only partially train the teacher model 110. A portion of each iteration (see FIG. 1, block 140) is the updating of the teacher model 110 through knowledge distillation.

At block 420, communication module 320 distributes, via a network 355 from the server 105 to a plurality of connected vehicles 115, a set of teacher-model parameters 230 associated with the teacher model 110. As discussed above, the set of teacher-model parameters 230 specifies or defines the teacher model 110. In some embodiments, the set of teacher-model parameters includes neural-network weights of the at least partially trained teacher model 110. As also discussed above, the set of teacher-model parameters 230 is sufficient to enable a connected vehicle 115 to simulate what the output of the teacher model 110 would be, given the local input training data at the connected vehicle 115. This makes it possible for the onboard computing system of a connected vehicle 115 to perform knowledge distillation on its locally hosted student model 120.

At block 430, communication module 320 receives, via the network 355 at the server 105 from each connected vehicle 115 in the plurality of connected vehicles 115, a set of student-model parameters 340 associated with a student model 120 trained at that connected vehicle 115 through execution of a second training procedure that employs local vehicle input data and knowledge distillation to teach the student model 120 to mimic the teacher model 110 based on the set of teacher-model parameters 230. As explained above, the student model 120 in each connected vehicle 115 in the plurality of connected vehicles 115 is less complex than the teacher model 110 and is customized, via the second training procedure, for that connected vehicle 115. The training of the student models 120 in the respective connected vehicles 115 and the uploading, to the server 105, of the sets of student-model parameters 340 are discussed in greater detail above in connection with FIG. 1, blocks 130 and 135.

At block 440, update module 325 executes, at the server 105, a third training procedure that includes knowledge distillation in which a combined machine-learning-based model based on the sets of student-model parameters 340 is used as a quasi-teacher model to update the teacher model 110. The teacher model 110 is treated, during the third training procedure, as a quasi-student model, as discussed above in connection with FIG. 1, block 140. As also discussed above, how the sets of student-model parameters 340 from a plurality of connected vehicles 115 are combined differs, depending on the embodiment. In some embodiments, the parameters 340 of the student models 120 are averaged or combined via a weighted average. Alternatively, the knowledge distillation process can be performed N separate times, once for each student model 120 (i.e., once for each uploaded set of student-model parameters 340), and then mathematical techniques can be used to combine the results/outputs from the N separate, different knowledge distillations.

If convergence module 330 determines, at block 450, that one or more predetermined convergence criteria have been satisfied, method 400 proceeds to block 460. Otherwise, the method returns to block 420 to begin another iteration (repetition cycle). Refer to FIG. 1, blocks 125, 130, 135, and 140.

At block 460, after the one or more predetermined convergence criteria have been satisfied, the vehicular application, instantiated in at least one connected vehicle 115 in the plurality of connected vehicles 115, controls operation of the at least one connected vehicle 115 based, at least in part, on the student model 120 in the at least one connected vehicle 115. That is, the vehicular application implemented in a connected vehicle 115 makes use of the trained student model 120. As discussed above, such control can include manipulation of a variety of vehicle settings and functions, including, without limitation, acceleration, braking, and steering.

Method 400 can differ in some respects, depending on the embodiment. For example, in some embodiments, the server 105 distributes to the connected vehicles 115, in the set of teacher-model parameters 230, a complete set of weights defining the teacher model 110. In other embodiments, the set of teacher-model parameters 230 includes a subset of the complete set of parameters defining the teacher model 110. In those embodiments, a tool such as the Fisher Information Matrix can be used to identify the important weights of the teacher model 110 (the weights having the greatest impact on the model's performance), and a student model 120 having the same architecture can be trained with a penalty on altering the important weights of the teacher model 110 (e.g., Elastic Weight Consolidation). In some embodiments, the local vehicle input data includes one or more of images, LIDAR data, radar data, sonar data, driver-monitoring data, CAN-bus data, IMU data, dead-reckoning data, and GPS data. In some embodiments, the student models 120 in the plurality of connected vehicles 115 have the same underlying architecture as the teacher model 110. In other embodiments, the student models 120 have a different underlying architecture from that of the teacher model, which is one of the advantages of the knowledge-distillation approach described herein.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The components described above can be realized in hardware or a combination of hardware and software and can be realized in a centralized fashion in one processing system or in a distributed fashion where different elements are spread across several interconnected processing systems. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A system for customized machine-learning-based model simplification for connected vehicles, the system comprising:
a processor; and
a memory storing machine-readable instructions that, when executed by the processor, cause the processor to:
execute a first training procedure to train a teacher model, wherein the teacher model is a machine-learning-based model pertaining to a vehicular application; and
perform the following repeatedly until one or more predetermined convergence criteria have been satisfied:
distribute, via a network to a plurality of connected vehicles, a set of teacher-model parameters associated with the teacher model;
receive, via the network from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters, wherein the student model in each connected vehicle in the plurality of connected vehicles is less complex than the teacher model and is customized, via the second training procedure, for that connected vehicle; and
execute a third training procedure including second knowledge distillation in which a combined machine-learning-based model based on the sets of student-model parameters is used as a quasi-teacher model to update the teacher model, the teacher model being treated, during the third training procedure, as a quasi-student model;
wherein, after the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

2. The system of claim 1, wherein the set of teacher-model parameters includes a complete set of parameters defining the teacher model.

3. The system of claim 1, wherein the set of teacher-model parameters includes a subset of a complete set of parameters defining the teacher model, the subset including parameters identified as being particularly important for defining the teacher model.

4. The system of claim 1, wherein the local vehicle input data includes one or more of images, Light Detection and Ranging (LIDAR) data, radar data, sonar data, driver-monitoring data, Controller-Area-Network (CAN) bus data, Inertial-Measurement-Unit (IMU) data, dead-reckoning data, and Global-Positioning-System (GPS) data.

5. The system of claim 1, wherein the student models in the plurality of connected vehicles have a same underlying architecture as the teacher model.

6. The system of claim 1, wherein the student models in the plurality of connected vehicles have a different underlying architecture from an underlying architecture of the teacher model.

7. The system of claim 1, wherein the vehicular application is one of computer vision, a range-estimation service, a distracted-driver-detection application, an impaired-driver-detection application, and an application that automatically customizes vehicle settings for a particular driver.

8. A non-transitory computer-readable medium for customized machine-learning-based model simplification for connected vehicles and storing instructions that, when executed by a processor, cause the processor to:
execute a first training procedure to train a teacher model, wherein the teacher model is a machine-learning-based model pertaining to a vehicular application; and
perform the following repeatedly until one or more predetermined convergence criteria have been satisfied:
distribute, via a network to a plurality of connected vehicles, a set of teacher-model parameters associated with the teacher model;
receive, via the network from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters, wherein the student model in each connected vehicle in the plurality of connected vehicles is less complex than the teacher model and is customized, via the second training procedure, for that connected vehicle; and
execute a third training procedure including second knowledge distillation in which a combined machine-learning-based model based on the sets of student-model parameters is used as a quasi-teacher model to update the teacher model, the teacher model being treated, during the third training procedure, as a quasi-student model;
wherein, after the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

9. The non-transitory computer-readable medium of claim 8, wherein the set of teacher-model parameters includes a complete set of parameters defining the teacher model.

10. The non-transitory computer-readable medium of claim 8, wherein the set of teacher-model parameters includes a subset of a complete set of parameters defining the teacher model, the subset including parameters identified as being particularly important for defining the teacher model.

11. The non-transitory computer-readable medium of claim 8, wherein the local vehicle input data includes one or more of images, Light Detection and Ranging (LIDAR) data, radar data, sonar data, driver-monitoring data, Controller-Area-Network (CAN) bus data, Inertial-Measurement-Unit (IMU) data, dead-reckoning data, and Global-Positioning-System (GPS) data.

12. The non-transitory computer-readable medium of claim 8, wherein the student models in the plurality of connected vehicles have a same underlying architecture as the teacher model.

13. The non-transitory computer-readable medium of claim 8, wherein the student models in the plurality of connected vehicles have a different underlying architecture from an underlying architecture of the teacher model.

14. A method, comprising:
executing a first training procedure to train a teacher model hosted by a server, wherein the teacher model is a machine-learning-based model pertaining to a vehicular application; and
performing the following repeatedly until one or more predetermined convergence criteria have been satisfied:
distributing, via a network from the server to a plurality of connected vehicles, a set of teacher-model parameters associated with the teacher model;
receiving, via the network at the server from each connected vehicle in the plurality of connected vehicles, a set of student-model parameters associated with a student model trained at that connected vehicle through execution of a second training procedure that employs local vehicle input data and first knowledge distillation to teach the student model to mimic the teacher model based on the set of teacher-model parameters, wherein the student model in each connected vehicle in the plurality of connected vehicles is less complex than the teacher model and is customized, via the second training procedure, for that connected vehicle; and
executing, at the server, a third training procedure including second knowledge distillation in which a combined machine-learning-based model based on the sets of student-model parameters is used as a quasi-teacher model to update the teacher model, the teacher model being treated, during the third training procedure, as a quasi-student model;
wherein, after the one or more predetermined convergence criteria have been satisfied, the vehicular application, instantiated in at least one connected vehicle in the plurality of connected vehicles, controls operation of the at least one connected vehicle based, at least in part, on the student model in the at least one connected vehicle.

15. The method of claim 14, wherein the set of teacher-model parameters includes a complete set of parameters defining the teacher model.

16. The method of claim 14, wherein the set of teacher-model parameters includes a subset of a complete set of parameters defining the teacher model, the subset including parameters identified as being particularly important for defining the teacher model.

17. The method of claim 14, wherein the local vehicle input data includes one or more of images, Light Detection and Ranging (LIDAR) data, radar data, sonar data, driver-monitoring data, Controller-Area-Network (CAN) bus data, Inertial-Measurement-Unit (IMU) data, dead-reckoning data, and Global-Positioning-System (GPS) data.

18. The method of claim 14, wherein the student models in the plurality of connected vehicles have a same underlying architecture as the teacher model.

19. The method of claim 14, wherein the student models in the plurality of connected vehicles have a different underlying architecture from an underlying architecture of the teacher model.

20. The method of claim 14, wherein the vehicular application is one of computer vision, a range-estimation service, a distracted-driver-detection application, an impaired-driver-detection application, and an application that automatically customizes vehicle settings for a particular driver.
